(19) United States
(12) Patent Application Publication
(10) Pub. No.: US 2010/0116441 A1
(43) Pub. Date: May 13, 2010

(54) PORTABLE HEAT SEALING APPARATUS

(75) Inventors: Mao Bang Tsai, Shenzhen City (CN); James Cheney, Clovelly (AU); Daniel John Curley, Glasgow (GB)

Correspondence Address: RABIN & Berdo, PC, 1101 14TH STREET, NW, SUITE 500, WASHINGTON, DC, 20005, US

(73) Assignees: Mao Bang Tsai, Guangdong (CN); James Cheney, New South Wales (AU)

(21) Appl. No.: 12/412,793

(22) Filed: Mar. 27, 2009

Related U.S. Application Data
(63) Continuation-in-part of application No. 12/269,252, filed on Nov. 12, 2008.

(51) Int. Cl. B30B 15/34

(52) U.S. Cl. 156/583.9

(57) ABSTRACT

The present invention is a portable heat sealing apparatus. The portable heat sealing apparatus comprises a body, a heating module, an upper case and a power module. The heating module has an elongated heating element held taut by two elastic elements to ensure a smooth, continuous bond between facing surfaces of a plastic bag.

### CROSS-REFERENCE TO RELATED APPLICATIONS

This application is a continuation-in-part patent application of U.S. application Ser. No. 12/269,252 filed on Nov. 12, 2008, the entire contents of which are hereby incorporated by reference for which priority is claimed under 35 U.S.C. § 120.

### FIELD OF THE INVENTION

The present invention relates to a portable heat sealing apparatus such as a heat sealing apparatus used in a kitchen to close and seal bags of thermoplastic material.

### BACKGROUND OF THE INVENTION

Generally, two major types of sealing machine exist. One is a stationary sealing machine, and the other is a portable sealing machine. Both types have advantages and disadvantages. Stationary sealing machines are used most often for large packages and provide better sealing performance but consume lots of electrically. Portable sealing machines are used most often as kitchen appliances to seal smaller packages and consume less power. However, sealing machines with the advantages of both types are not available in the market. Therefore, people either have to buy both or accept the inherent disadvantages of the one they purchase.

Because conventional portable sealing machines are small and have a small heat sealing region of 1˜2 centimeters, they are easy for people to grip and squeeze. However, sealing a large plastic bag smoothly and efficiently requires that a person operating the machine apply a consistent pressure and slide the plastic bag continuously and smoothly along the heating region, which can be challenging. Using sealing machines with a longer heat sealing region with a longer heating module results in the longer heating module stretching and becoming slack.

Conventional sealing machines generally comprise a base, a power module, a cover, a heating module and optional over-current protection. When the cover is pressed toward the base, power is provided to the heating module, and the heating module generates heat to seal a plastic bag. The over-current protection is provided in a circuit that will deactivate the heating module to prevent the sealing machine from overheating and damaging the sealing machine. However, it only protects the sealing machine itself but not a person operating the sealing machine. For example, if a child plays with the sealing machine and does not notice or understand that the heating module is activated, she or he may be burned.

### SUMMARY OF THE INVENTION

The objective of the present invention is to provide a portable heat sealing apparatus with a longer heating element that is kept taut so bonded seals are smooth and continuous and can be used to effectively and efficiently close and seal large plastic bags.

The portable heat sealing apparatus in accordance with the present invention comprises a body, a heating module, an upper case and a power module. The heating module has an elongated heating element held taut by two elastic elements to ensure a smooth, continuous bond between facing surfaces of a plastic bag.

### BRIEF DESCRIPTIONS OF THE DRAWINGS

FIG. 1 is a perspective view of a portable heat sealing apparatus in accordance with the present invention;

FIG. 2 is an exploded, bottom-rear perspective view of the portable heat sealing apparatus in FIG. 1;

FIG. 3 is an exploded, bottom-rear perspective view of an upper case of the portable heat sealing apparatus in FIG. 1;

FIG. 4a is an exploded perspective view of a base and cover of the portable heat sealing apparatus in FIG. 1;

FIG. 4b is an enlarged perspective view of one end of a heating module mounted in the base of the portable heat sealing apparatus in FIG. 4a;

FIG. 5 is an exploded perspective view of a heating module of the portable heat sealing apparatus in FIG. 4a;

FIG. 6 is a top-front perspective view of the base of the portable heat sealing apparatus in FIG. 4a;

FIG. 7a is a circuit diagram of a driving circuit of the portable heat sealing apparatus in FIG. 1 using a DC power source;

FIG. 7b is a circuit diagram of a driving circuit of the portable heat sealing apparatus in FIG. 1 using an AC power source;

FIG. 8 is an exploded, bottom-rear perspective view of the portable heat sealing apparatus in FIG. 1 with a hanger assembly comprising a hanger panel and two wall connectors;

FIG. 9 is an exploded, bottom-rear perspective view of the portable heat sealing apparatus in FIG. 1 with a hanger assembly comprising multiple suction cups.

### DETAILED DESCRIPTION OF THE PRESENT INVENTION

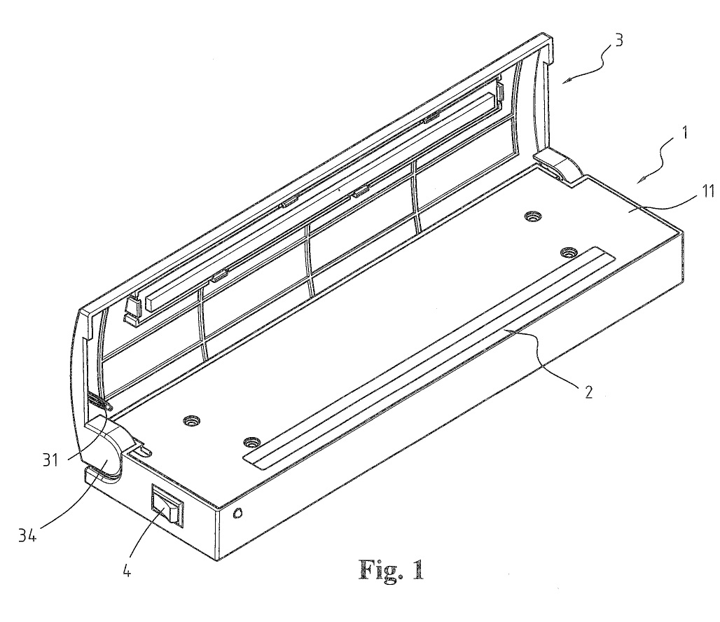

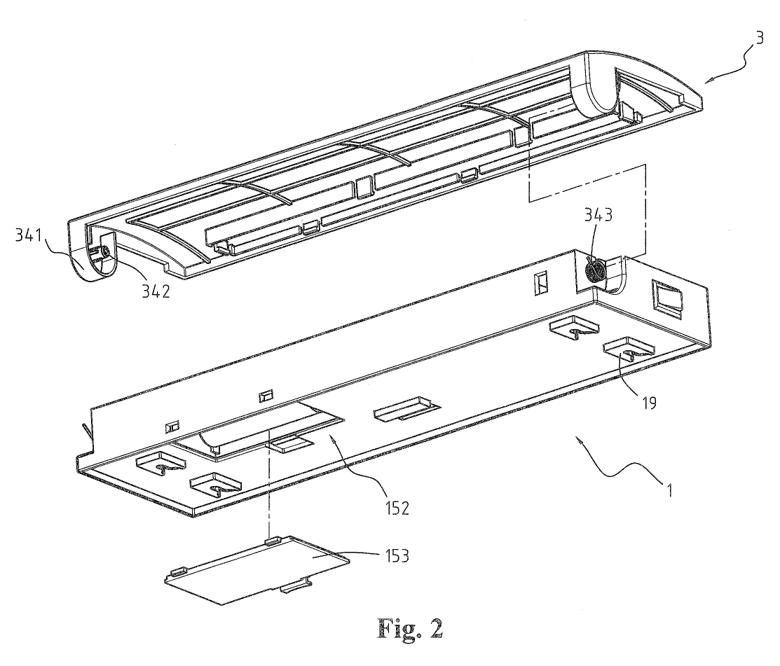

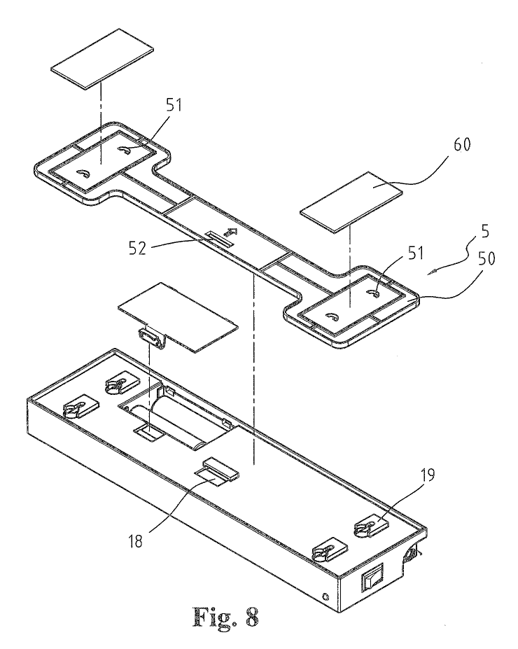

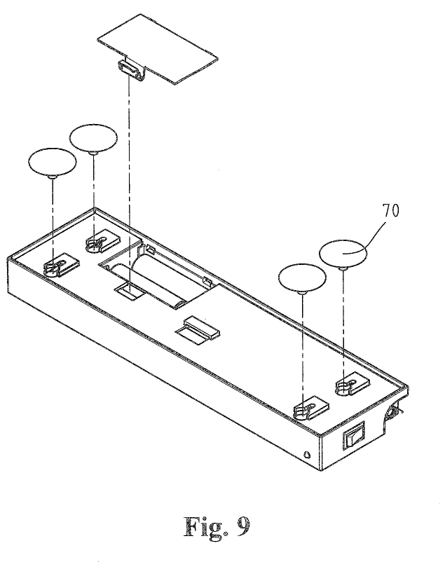

With reference to FIGS. 1, 2, 8 and 9, a portable heat sealing apparatus in accordance with the present invention closes and seals plastic bags quickly and efficiently and comprises a body (1), a heating module (2), an upper case (3), a power module (4) and an optional hanger assembly (5).

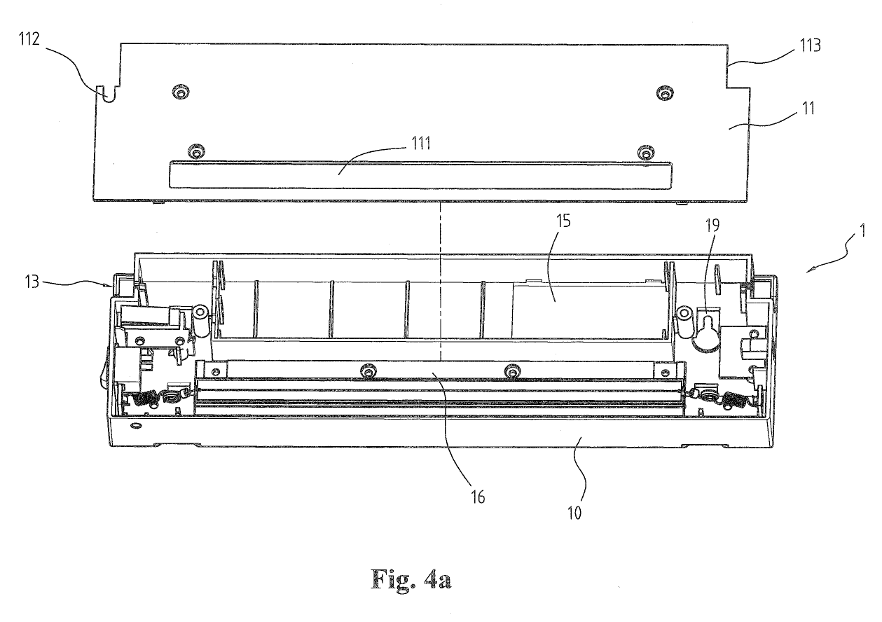

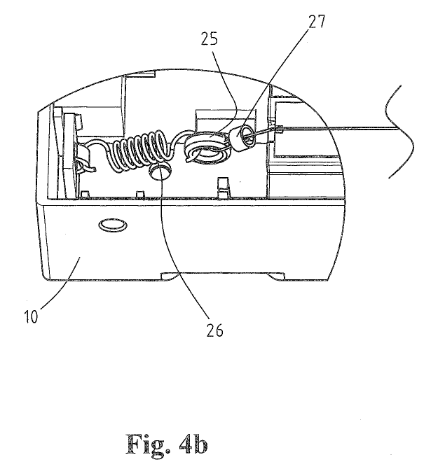

With further reference to FIGS. 4a and 4b, the body (1) comprises a base (10) and an optional cover (11).

The base (10) has two ends, a rear wall, a front wall, an outer surface, an open top and a bottom surface and comprises two optional hinge slots (13), a heating module compartment (16), a battery compartment (15) and multiple optional transverse mounting slots (19), at least one optional hanging lip (18) or both.

The rear wall has an optional electrical cord hole.

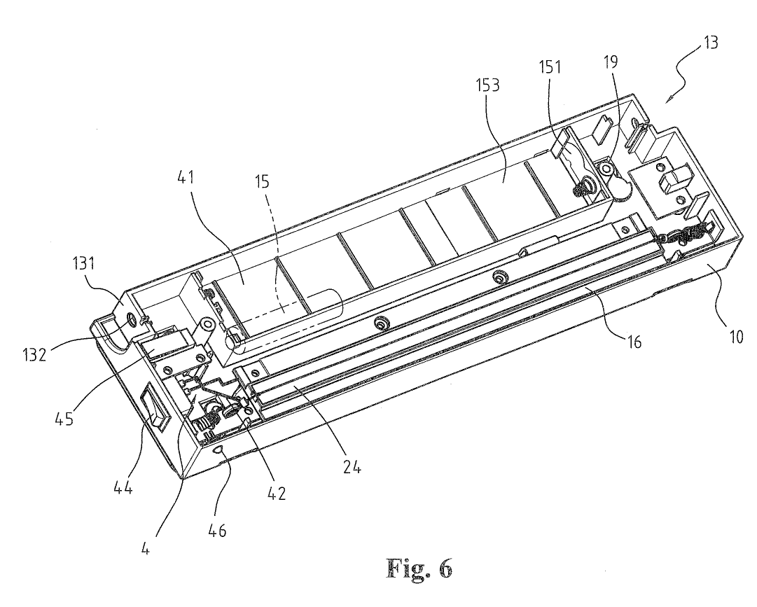

With further reference to FIG. 6, the hinge slots (13) are formed respectively on the ends of the base (10) and communicate with the rear wall, and each hinge slot (13) has an inner wall (131) and a mounting hole (132). The inner wall (131) is parallel to the end wall. The mounting hole (132) is formed through the inner wall (131) and aligns with the mounting hole (132) in the inner wall (131) of the other hinge slot (13).

The heating module compartment (16) is formed in the base (10) between the ends and may be adjacent to the front wall.

The battery compartment (15) is formed inside the base (10), may be formed against the rear wall and has at least two contacts (151), a battery access hole (152) and a battery access panel (153). The battery access hole (152) is formed through the bottom surface of the base (10) and communicates with the battery compartment (15). The battery access panel (153) is removably mounted in and closes the battery access hole (152).

The multiple transverse mounting slots (19) are eccentric holes formed through the bottom surface of the base (10).

The at least one hanging lip (18) is formed on and protrudes from the bottom surface of the base (10).

The cover (11) is mounted on and closes the open top of the base (10) and has a front edge, two rear corners, a heating slot (111), two optional hinge notches (113) and an optional activation hole (112).

The heating slot (111) is formed through the cover (11), may be near the front edge and corresponds to the heating module compartment (16) in the base (10).

The hinge notches (113) are formed respectively in the rear corners and correspond respectively to the hinge slots (13) in the base (10).

The activation hole (112) is formed through the cover (11) near one end.

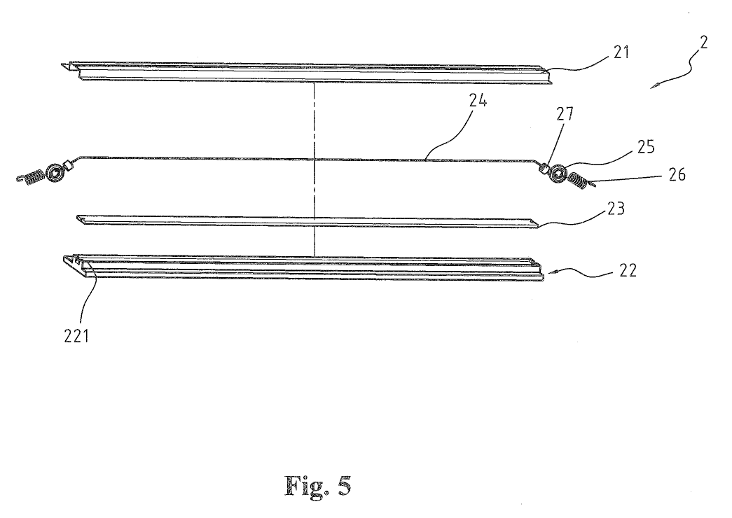

With further reference to FIG. 5, the heating module (2) is mounted longitudinally in the base (10), protrudes through the heating slot (111) in the cover (11) and comprises an adiabatic stand (22), an adiabatic pad (23), a heating element (24), two isolation devices (25), two elastic elements (26) and an adiabatic sheet (21).

The adiabatic stand (22) has a longitudinal ridge (221).

The adiabatic pad (23) is mounted longitudinally on the longitudinal ridge (221) of the adiabatic stand (22);

The heating element (24) generates heat when current passes through it, is mounted longitudinally on the adiabatic pad (23), is at least 10 cm in length, has two ends, may be a resistance wire of a metal alloy of 70% Fe, 25% Cr and 5% Al, is always held under tension ranging from 500 gm when cold to 300 gm when hot and has two electrical connectors (27). The electrical connectors (27) are mounted respectively on the ends of the heating element and may be brass rings mounted respectively around ends of the heating element (24).

The isolation devices (25) are connected respectively to the ends of the heating element (24), are thermal and electrical insulators and may be ceramic rings.

The elastic elements (26) are connected respectively to the ends of the base (10) and respectively to the isolation devices (25) to hold the heating element (24) taut and securely on the adiabatic pad (23) and in the base (10).

The adiabatic sheet (21) covers the heating element (24) and the adiabatic pad (23) so the heating element (24) will not burn a hole in a plastic bag being sealed by the heat sealing apparatus.

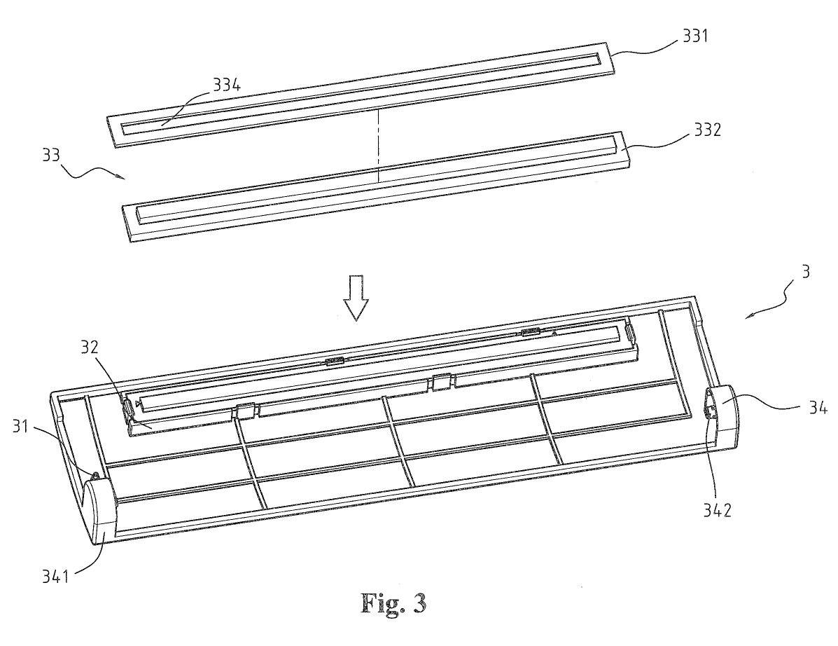

With further reference to FIG. 3. the upper case (3) is connected pivotally to and covers the base (10), presses a plastic bag against the adiabatic sheet (21) so the heating element (24) can heat and seal the plastic bag, has an inner surface, two ends, a rear edge and a front edge and comprises an optional activation rod (31), a mounting slot (32), a press (33) and two optional hinges (34).

The activation rod (31) is formed on and protrudes down from the upper case (3) and corresponds to and presses through the activation hole (112) when the upper case (3) is pressed against the base (10).

The mounting slot (32) is formed parallel to the front edge of the upper case (3) and corresponds to the heating module (2).

The press (33) comprises a contact pad (332) and a mounting frame (331).

The contact pad (332) is a strip of resilient material, is mounted securely in the mounting slot (32) and has two exposed surfaces. The exposed surfaces comprise a recessed outer surface and a protruding central surface. The recessed outer surface is used to hold the contact pad in the mounting slot (331). The protruding central surface presses a plastic bag against the adiabatic sheet (21) to ensure a smooth and efficient seal.

The mounting frame (331) is a strip of stiff insulating material, has a central longitudinal through hole (334) corresponding to the protruding central surface of the contact pad (332), is mounted in the mounting slot (32) against the recessed surface of the contact pad (332) around the protruding central surface and holds the press (33) securely in the mounting slot (32).

The hinges (34) are formed respectively on the two ends at the rear edge, protrude down from the inner surface and correspond to and are mounted pivotally respectively in the two hinge slots (13) in the base (10), and each hinge (34) has a leaf (341), a pintle (342) and a resilient element (343). The leaf (341) protrudes down from the inner surface of the upper case (3) and corresponds to and is mounted pivotally in the corresponding hinge slot (13) in the base (10). The pintle (342) is formed on and protrudes in from the leaf (341) and is mounted rotatably in the mounting hole (132) in the corresponding hinge slot (13). The resilient element (343) is mounted around the pintle (342), keeps the upper case (3) from resting against the base (10) and may be a torsional spring.

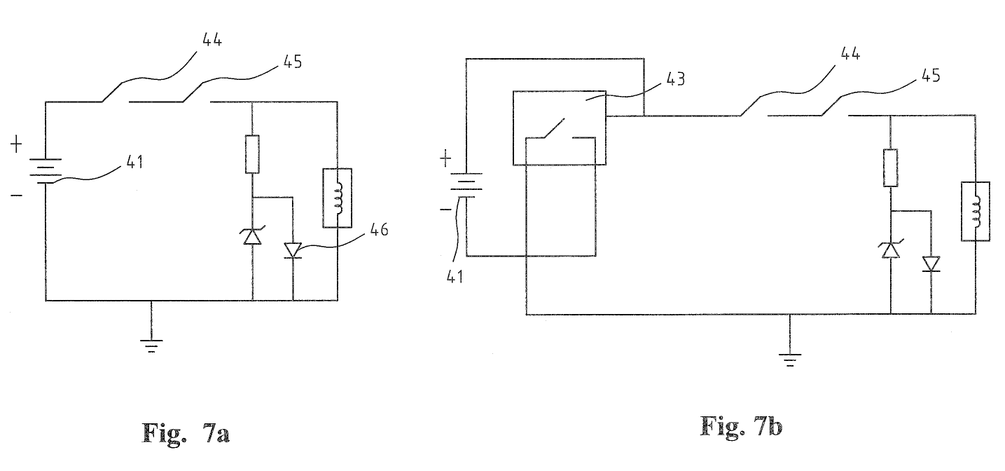

With reference to FIGS. 6 and 7b, the power module (4) provides DC power to electrical components of the portable heat sealing apparatus and comprises at least one optional battery (41), an optional circuit board, an optional electric cord (42), an optional rectifier (43), an optional selector switch, an enabling switch (44), an optional safety switch (45) and an optional visual indicator (46) (such as an LED).

The at least one battery (41) is mounted in the battery compartment (15), connects to the contacts (151) in the battery compartment (15), is removable and provides DC power to operate the portable heat sealing apparatus.

The circuit board is mounted in the base (10) and connects electrical components of the portable heat sealing apparatus to a DC power source.

The electric cord (42) connects to an external AC power source and extends though the electrical cord hole in the rear wall into the body (10).

The rectifier (43) is mounted in the base (10), is connected to the electric cord (42) to convert AC power to DC power and provides DC power.

The selector switch is mounted in the base (10) and selects either the at least one battery (41) or the rectifier (43) as the DC power source.

The enabling switch (44) is mounted inside the base (10), protrudes through the outer surface and enables the portable heat sealing apparatus.

The safety switch (45) is a microswitch, is mounted inside the base (10), is aligned with the activation rod (31) and activates the portable heat sealing apparatus (43) when the upper case (3) is pressed toward the base (10).

The visual indicator (46) is connected in parallel with the heating element (24), shines when the portable heat sealing apparatus is operating, is mounted inside the base (10), protrudes through the outer surface and is connected electrically to the safety switch (45).

The hanger assembly (5) allows the portable heat sealing apparatus to be detachably mounted securely on a smooth surface and comprises a hanger panel (50) and at least one wall connector (60) or multiple suction cups (70).

The hanger panel (50) attaches to a vertical surface and the bottom surface of the base (10) and has a contact surface, an exposed surface and multiple optional hooks (51), at least one optional stationary hanger (52) or both. The contact surface attaches to a vertical surface. The exposed surface attaches to the base. The hooks (51) are formed on and protrude from the exposed surface of the hanger panel (50) and are engaged respectively by the transverse mounting slots (19) of the base (10) to securely hold the portable heat sealing apparatus. The at least one stationary hanger (52) is formed on and protrudes from the exposed surface of the hanger panel (50) and is complementary to and engaged respectively by the at least one hanging lip (18) on the base (10).

The at least one wall connector (60) connects the hanger panel (50) to a vertical surface, is connected securely to the contact surface of the hanger panel (50) and may be two-sided pressure tape, a magnet or the like.

The suction cups (70) are mounted detachably respectively in the transverse mounting slots (19) in the bottom surface of the base (10).

People skilled in the art will understand that various changes, modifications, and alterations in form and details may be made without departing from the spirit and scope of the invention.

What is claimed is:

1. A portable heat sealing apparatus comprising
a body comprises a base having two ends;
a heating module being mounted in the base;
an upper case being connected pivotally to and covering the base to press a plastic bag against the heating module; and
a power module.

2. A portable heat sealing apparatus as claimed in claim 1 further comprising a hanger assembly allowing the portable heat sealing apparatus to be detachably mounted securely on a smooth surface and comprises a hanger panel attaching to a vertical surface and the bottom surface of the base and having
a contact surface attaching to a vertical surface; and
an exposed surface attaching to the base.

3. A portable heat sealing apparatus as claimed in claim 1, wherein the base further has a rear wall, a front wall, an outer surface, an open top and a bottom surface.

4. A portable heat sealing apparatus as claimed in claim 1, wherein
the heating module is mounted longitudinally in the base and comprises
an adiabatic stand having a longitudinal ridge;
an adiabatic pad being mounted longitudinally on the longitudinal ridge;
a heating element generates heat when current passes through it, is mounted longitudinally on the adiabatic pad, is at least 10 cm in length, has two ends, is always held under tension ranging from 500 gm when cold to 300 gm when hot and has two electrical connectors mounted respectively on ends of the heating element;
two isolation devices are connected respectively to the ends of the heating element and being thermal and electrical insulators;
two elastic elements being connected respectively to the ends of the base and respectively to the isolation devices to hold the heating element taut and securely on the adiabatic pad and in the base; and
an adiabatic sheet covering the heating element and the adiabatic pad so the heating element will not burn a hole in a plastic bag being sealed by the heat sealing apparatus;
the upper case presses a plastic bag against the adiabatic sheet so the heating element can heat and seal the plastic bag, has an inner surface, two ends, a rear edge and a front edge and comprises
an activation rod being formed on and protruding down from the upper case;
a mounting slot being formed parallel to the front edge of the upper case and corresponding to the heating module;
a press comprises
a contact pad being a strip of resilient material, being mounted securely in the mounting slot and having two exposed surfaces comprising
a recessed outer surface being used to hold the contact pad in the mounting slot; and
a protruding central surface pressing a plastic bag against the adiabatic sheet to ensure a smooth and efficient seal.; and
a mounting frame being a strip of stiff insulating material, having a central longitudinal through hole corresponding to the protruding central surface of the contact pad, being mounted in the mounting slot against the recessed surface of the contact pad around the protruding central surface and holding the press securely in the mounting slot; and
the power module provides DC power to electrical components of the portable heat sealing apparatus and comprises
a battery compartment being formed inside the base and has
at least two contacts;
a battery access hole being formed through the bottom surface of the base and communicating with the battery compartment; and
at least one battery being mounted in the battery compartment, connecting to the contacts in the battery compartment, being removable and providing DC power to operate the portable heat sealing apparatus;
a circuit board being mounted in the base and connecting electrical components of the portable heat sealing apparatus to a DC power source;
an enabling switch being mounted inside the base, protruding through the outer surface and enabling the portable heat sealing apparatus;
a safety switch being a microswitch, being mounted inside the base, being aligned with the activation rod and activating the portable heat sealing apparatus when the upper case is pressed toward the base; and
a visual indicator being connected in parallel with the heating element, shining when the portable heat sealing apparatus is operating, being mounted inside the base, protruding through the outer surface and being connected electrically to the safety switch.

5. A portable heat sealing apparatus as claimed in claim 1, wherein
the heating module is mounted longitudinally in the base and comprises
an adiabatic stand having a longitudinal ridge;
an adiabatic pad being mounted longitudinally on the longitudinal ridge;
a heating element generating heat when current passes through it, being mounted longitudinally on the adiabatic pad, being at least 10 cm in length, having two ends, always being held under tension ranging from 500 gm when cold to 300 gm when hot and having two electrical connectors being mounted respectively on ends of the heating element;
two isolation devices being connected respectively to the ends of the heating element and being thermal and electrical insulators;
two elastic elements being connected respectively to the ends of the base and respectively to the isolation devices to hold the heating element taut and securely on the adiabatic pad and in the base; and
an adiabatic sheet covering the heating element and the adiabatic pad so the heating element will not burn a hole in a plastic bag being sealed by the heat sealing apparatus;
the upper case presses a plastic bag against the adiabatic sheet so the heating element can heat and seal the plastic bag, has an inner surface, two ends, a rear edge and a front edge and comprises
an activation rod being formed on and protruding down from the upper case;
a mounting slot being formed parallel to the front edge of the upper case and corresponding to the heating module;
a press comprising
a contact pad being a strip of resilient material, being mounted securely in the mounting slot and having two exposed surfaces comprising
a recessed outer surface being used to hold the contact pad in the mounting slot; and
a protruding central surface pressing a plastic bag against the adiabatic sheet to ensure a smooth and efficient seal.; and
a mounting frame being a strip of stiff insulating material, having a central longitudinal through hole corresponding to the protruding central surface of the contact pad, being mounted in the mounting slot against the recessed surface of the contact pad around the protruding central surface and holding the press securely in the mounting slot; and
the power module provides DC power to electrical components of the portable heat sealing apparatus and comprises
a circuit board being mounted in the base and connecting electrical components of the portable heat sealing apparatus to a DC power source;
an electric cord being connected to an external AC power source and extending though the electrical cord hole in the rear wall into the body;
an enabling switch being mounted inside the base, protruding through the outer surface and enabling the portable heat sealing apparatus;
a safety switch being a microswitch, being mounted inside the base, being aligned with the activation rod and activating the portable heat sealing apparatus when the upper case is pressed toward the base; and
a visual indicator being connected in parallel with the heating element, shining when the portable heat sealing apparatus is operating, being mounted inside the base, protruding through the outer surface and being connected electrically to the safety switch.

6. A portable heat sealing apparatus as claimed in claim 2, wherein the hanger assembly comprises at least one wall connector.

7. A portable heat sealing apparatus as claimed in claim 2, wherein the hanger assembly comprises multiple suction cups.

8. A portable heat sealing apparatus as claimed in claim 3, wherein
the heating element is a resistance wire of a metal alloy of 70% Fe, 25% Cr and 5% Al and the electrical connectors are brass rings mounted respectively around ends of the heating element; and
the isolation devices are ceramic rings.

9. A portable heat sealing apparatus as claimed in claim 4, wherein
the rear wall of the base has an electrical cord hole;
the power module further comprises
an electric cord connecting to an external AC power source and extending though the electrical cord hole in the rear wall into the body;
a rectifier being mounted in the base and connected to the electric cord to convert AC power to DC power and provides DC power; and
a selector switch being mounted in the base and selecting either the at least one battery or the rectifier as the DC power source.

10. A portable heat sealing apparatus as claimed in claim 4, wherein
the rear wall of the base has an electrical cord hole;
the heating module is mounted longitudinally in the base and comprises
an adiabatic stand having a longitudinal ridge;
an adiabatic pad being mounted longitudinally on the longitudinal ridge;
a heating element generates heat when current passes through it, is mounted longitudinally on the adiabatic pad, is at least 10 cm in length, has two ends, is always held under tension ranging from 500 gm when cold to 300 gm when hot and has two electrical connectors mounted respectively on ends of the heating element;
two isolation devices are connected respectively to the ends of the heating element and being thermal and electrical insulators;
two elastic elements being connected respectively to the ends of the base and respectively to the isolation devices to hold the heating element taut and securely on the adiabatic pad and in the base; and
an adiabatic sheet covering the heating element and the adiabatic pad so the heating element will not burn a hole in a plastic bag being sealed by the heat sealing apparatus;
the upper case presses a plastic bag against the adiabatic sheet so the heating element can heat and seal the plastic bag, has an inner surface, two ends, a rear edge and a front edge and comprises
an activation rod being formed on and protruding down from the upper case;
a mounting slot being formed parallel to the front edge of the upper case and corresponding to the heating module;
a press comprises
a contact pad being a strip of resilient material, being mounted securely in the mounting slot and having two exposed surfaces comprising
a recessed outer surface being used to hold the contact pad in the mounting slot; and
a protruding central surface pressing a plastic bag against the adiabatic sheet to ensure a smooth and efficient seal; and
a mounting frame being a strip of stiff insulating material, having a central longitudinal through hole corresponding to the protruding central surface of the contact pad, being mounted in the mounting slot against the recessed surface of the contact pad around the protruding central surface and holding the press securely in the mounting slot; and
the power module provides DC power to electrical components of the portable heat sealing apparatus and comprises
a circuit board being mounted in the base and connecting electrical components of the portable heat sealing apparatus to a DC power source;
an electric cord connecting to an external AC power source and extending though the electrical cord hole in the rear wall into the body;
a rectifier being mounted in the base and being connected to the electric cord to convert AC power to DC power and provides DC power;
an enabling switch being mounted inside the base, protruding through the outer surface and enabling the portable heat sealing apparatus;
a safety switch being a microswitch, being mounted inside the base, being aligned with the activation rod and activating the portable heat sealing apparatus when the upper case is pressed toward the base; and
a visual indicator being connected in parallel with the heating element, shining when the portable heat sealing apparatus is operating, being mounted inside the base, protruding through the outer surface and being connected electrically to the safety switch.

11. A portable heat sealing apparatus as claimed in claim 4, wherein
the body further comprises a cover being mounted on and closing the open top of the base and having
a front edge;
a heating slot being formed through the cover near the front edge and corresponding to the heating module compartment in the base;
the heating module protrudes through the heating slot; and
an activation hole being formed through the cover near one end; and
the activation rod protrudes through the activation hole when the upper case being pressed toward the body.

12. A portable heat sealing apparatus as claimed in claim 6, wherein
the base further comprises two hinge slots being formed respectively on the ends of the base and communicating with the rear wall, and each hinge slot having
an inner wall being parallel to the end wall; and
a mounting hole being formed through the inner wall and aligning with the mounting hole in the inner wall of the other hinge slot;
the cover further has
two rear corners; and
two hinge notches being formed respectively in the rear corners and corresponding respectively to the hinge slots in the base;
a heating module compartment being formed in the base between the ends;
a battery compartment being formed inside the base and has
at least two contacts;
a battery access hole being formed through the bottom surface of the base and communicating with the battery compartment; and
a battery access panel being removably mounted in and closing the battery access hole;
multiple transverse mounting slots being eccentric holes are formed through the bottom surface of the base; and
the hanger panel further has multiple hooks being formed on and protruding from the exposed surface of the hanger panel and being engaged respectively by the transverse mounting slots of the base.

13. A portable heat sealing apparatus as claimed in claim 4, wherein the base comprises;
two hinge slots being formed respectively on the ends of the base and communicating with the rear wall, and each hinge slot having
an inner wall being parallel to the end wall; and
a mounting hole being formed through the inner wall and aligning with the mounting hole in the inner wall of the other hinge slot;
a heating module compartment being formed in the base between the ends;
a battery compartment being formed inside the base and has
at least two contacts;
a battery access hole being formed through the bottom surface of the base and communicating with the battery compartment; and
a battery access panel being removably mounted in and closing the battery access hole; and
at least one hanging lip being formed on and protruding from the bottom surface of the base; and
the hanger panel further has at least one stationary hanger being formed on and protruding from the exposed surface of the hanger panel and being complementary to and engaged respectively by the at least one hanging lip on the base.

14. A portable heat sealing apparatus as claimed in claim 6, wherein the base comprising
the heating module compartment being adjacent to the front wall; and
the battery compartment being formed against the rear wall.

15. A portable heat sealing apparatus as claimed in claim 7, wherein the base comprising
the heating module compartment being adjacent to the front wall; and
the battery compartment being formed against the rear wall.
